(19) United States
(12) Patent Application Publication
(10) Pub. No.: US 2009/0022870 A1
(43) Pub. Date: Jan. 22, 2009

(54) Method of manufacturing a transparent gelatin shape collagen food made with tendon and pettitoe of cow

(76) Inventors: In Bong Cho, Los Angeles, CA (US); Sung Il Cho, Los Angeles, CA (US); Jinny Aliya Cho, Los Angeles, CA (US); Sung In Cho, Los Angeles, CA (US)

Correspondence Address: Eugene OAK, 610 S. Van Ness Ave., Los Angeles, CA, 90005, US

(21) Appl. No.: 11/880,078

(22) Filed: Jul. 20, 2007

(51) Int. Cl. A23L 1/312

(52) U.S. Cl. 426/574

(57) ABSTRACT

A method of manufacturing a gelatin shape collagen food, which contains a tendon structure therein, is provided. The method is comprised of: 1) boil tendons from a cow in water for 90 minutes, 2) quench the tendon with cold water at 15° C., 3) rip off meats from the tendons, 4) slice the tendons in a shape with a 5 mm thickness, 1 cm width and 10 cm length. At the same time 5) boil cow's pettitoe in water for one hour, 6) rip off skin of the cow pettitoe and remove fats by hand, 7) boil the cow's pettitoe again in water for 30 minutes to remove residual fat, 8) mix the sliced tendons and ripped off pettitoe in water in 1:1:4 volume ratios, add caramel drop, gelatin powders and apple cider, 9) boil down the mixtures prepared in the eighth step slowly for 1.5 hours, 10) put the mixture in a mold and quench as soon as possible, 11) dry out the gelatin structure by blowing air at room temperature for four hours, and 12) cut the gelatin structure into desired size.

### 1. FIELD OF THE INVENTION

Current application relates to a method of making a transparent gelatin shape food, especially relates to a method of manufacturing a gelatin shape side dish that is made with tendon of cow and collagen powder.

### 2. BACKGROUND OF THE INVENTION

As the world economy is growing, food becomes abundant, many snacks become popular and competition between them is severe. As a result, more sweeteners, salts, spices and seasonings are added to the food for strong taste and high calories. But, it is well known to public that too many additives and high calories may cause many internal diseases for the human body. They break balance of hormones to cause diabetes and raise blood pressure, etc. Therefore, as a repulsion of such artificially tasted food, naturally produced organic foods are chosen by more and more people. Most of those Organic foods have lower contents of sugar, fat, carbohydrates. Snacks also substitute sugar to other artificial sweetens. ‘Jello’ is one of the kids' most favorite snacks of these days. It contains only flavor and sugar or artificial sweeteners but no carbohydrates. Some of them contain pieces of fruits therein. It looks transparent and the fruit gives an impression that it might be healthy to eat it. But, those ‘Jello’s do not have any nutrition such as protein, minerals, etc. It is purpose of the current application to provide a method making of a ‘Jello’ like food that can provide protein and minerals to customer, which can be applied as a snack or side dish of a meal. It is another purpose to provide a protein enriched snack or side dishes for seniors, who can not bite and chew meat.

### Description of the Prior Art

U.S. Patent Application20050220960 to Godlewski, Joseph F. illustrates methods of making collagen protein breads, cereals, rice products, and pastas by combining an additive of ground (powdered) collagen to flour made of any grain or rice.

U.S. Patent Application20040253678 to Hsiao, Chin Ying; et al. illustrates a collagen production method wherein the collagen-containing tissues are fermented, to extract the collagen. The fermentation process employs microorganisms of bacteria and yeast.

U.S. Patent Application 20040010122 to Nnanna, Ifendu; et al. illustrates a method of extracting and fractionating collagen and derivatives from poultry skin tissue. The method is heating, separating, and rapidly cooling the solid-phase to exploit reformation of the helical forms which produces a high concentration of coils, a phenomenon that accounts for its ability to form cold-set thermal reversible gels and gel strength.

U.S. Pat. No. 6,682,760 to Noff, et al. illustrates a method for preparing cross-linked collagen and cross-linked collagen products. The method includes incubating collagen in a solution including water, sugar, and a buffer having a suitable pH and ionic strength to form cross-linked collagen. Removing excess un-reacted sugar and polar solvent by washing the cross-linked collagen or by other methods. The collagen is prepared from atelopeptide collagen to reduce antigenicity.

U.S. Pat. No. 6,660,280 to Allard, et al. illustrates a collagen product containing collagen of marine origin with a low odor. Complete sole skins are ground while still frozen. Grinding is continued until a finely divided until 5 mm size is obtained. The ground material obtained is washed twice in a phosphate buffer.

U.S. Pat. No. 5,785,983 to Furlan, et al. illustrates a method and apparatus for preparing non-porous transparent collagen sheet of 0.02 to 2 mm thickness Type I collagen gel with an H₂O content not exceeding 20% by weight. The sheet has a capacity for absorbing aqueous biological liquids limited to a maximum of 15 times its weight. It is suitable for the therapeutic treatment of wounds and burns.

U.S. Pat. No. 5,436,135 to Tayot, et al. illustrates a method of preparation of placenta collagen. Mammal placenta is subjected to moderate enzymatic digestion, with pepsin at an acid pH, followed by repeated separation and precipitation at an acid pH. Completely transparent, physiological and hemocompatible gels and solutions are prepared.

U.S. Pat. No. 5,411,887 to Sjolander illustrates a process for the production of collagen from animal intestines. The starting material is mixed with ice-water at a pH of 5.5, that the mixture is disintegrated and then heated to 40 to 42° C. and hydrolyzed at a pH of 10.5 using a proteolytic enzyme. After finishing of the hydrolyses pH is regulated to 5.5 and the collagen is separated and collected.

U.S. Pat. No. 5,322,648 to Dapper illustrates a method for fabricating a shaped article from aqueous collagen-containing materials. A dispersion containing collagen and a surfactant is cast upon a mold of thermoplastic material and dried by a ramped drying profile under controlled conditions of relative humidity and temperature.

U.S. Pat. No. 5,064,941 to Davison illustrates a method for extracting collagen from animal collagen-containing tissue using a solution of an organic diamine or amino-alcohol salt.

U.S. Pat. No. 5,043,426 to Goldstein illustrates a process for manufacturing organized collagen structures of human origin and the organized collagen structures corresponding thereto. A specimen of animal or human tissue is ground in a saline solution after washing and aseptization, in order to solubilize the collagen contained in said specimen. Then a catalyst is added for promoting the reconstitution of collagen fibers. The reconstituted organized structures are separated from the aqueous medium by centrifuging, and are then washed, aseptized, conditioned, lyophilized and sterilized. The collagen fibers appear in the isolated state is in the form of a web, ready for use. They display a periodicity of transverse striations comprised between 68 nm and 72 nm.

U.S. Pat. No. 4,687,518 to Miyata, et al. illustrates a method for manufacturing pyrogen-free collagen gels useful as contact lenses. The contact lenses is made by performing all manufacturing process steps under aseptic conditions.

U.S. Pat. No. 4,505,855 to Bruns, et al. illustrates a method for forming the native, non-fibrilized, highly transparent collagen material comprises ultra centrifuging a purified solution of native collagen to form a pellet of transparent collagen material and fixing the pellet of collagen material to form a rigid, leather-like material. The collagen material can also be used for prosthetic replacement of other bodily tissues, such as nucleus pulposus, cartilage, and vitreous body.

U.S. Pat. No. 4,407,829 to Sjolander illustrates a method of manufacturing collagen products, wherein slurry, various parts of the digestive system are used as starting material and are reduced and suspended, after which the collagen is extracted, cleaned and brought into a slurry state.

None of the prior art teaches how to make a food made from tendon of cow and collagen powder as shown in the current application.

### SUMMARY OF THE INVENTION

As the world economy is growing, food becomes abundant, many snacks become popular and competition between them is severe. As a result, more sweeteners, salts, spices and seasonings are added to the food for strong taste and high calories. However, it is well known to public that too many additives and high calories may cause many internal diseases for the human body. Therefore, as a repulsion of such artificially tasted food, naturally produced organic foods are chosen by more and mpre people. Most of those Organic foods have lower contents of sugar, fat, and carbohydrates. ‘Jello’ is one of the kids' most favorite snacks of these days. It contains only flavor and sugar or artificial sweeteners but no carbohydrates. Some of them contain pieces of fruits therein. The ‘Jello’ snack looks transparent and the fruit gives an impression that it might be healthy to eat it. But, those ‘Jello’s do not have any nutrition such as protein, minerals, etc. It is the purpose of the current application to provide a method making of a ‘Jello’ look like food that can provide protein and minerals to the customer, which can be applied as a snack or side dish of a meal. The method is comprised of: 1) boil tendons from a cow in water for 90 minutes, 2) quench the tendon with cold water at 15° C., 3) rip off meats from the tendons, 4) slice the tendons in a shape with a 5 mm thickness, 1 cm width and 10 cm length. At the same time 5) boil cow's pettitoe in water for one hour, 6) rip off skin of the cow pettitoe and remove fats by hand, 7) boil the cow's pettitoe again in water for 30 minutes to remove residual fat, 8) mix the sliced tendons and ripped off pettitoe in water in 1:1:4 volume ratios, add caramel drop, gelatin powders and apple cider, 9) boil down the mixtures prepared in the eighth step slowly for 3 hours, 10) put the mixture in a mold and quench as soon as possible, 11) dry out the gelatin structure by blowing air at room temperature for four hours, and 12) cut the gelatin structure into desired size.

### BRIEF DESCRIPTION OF THE DRAWINGS

FIG. 1 is a schematic drawing of the procedure of manufacturing a gelatin shape collagen food made with tendon, pettitoe of cow and collagen powder according to current application.

FIG. 2 is a photograph of molded gelatin shape collagen food made with tendon, pettitoe of cow and collagen powder according to current application.

FIG. 3 is a photograph of sliced gelatin shape collagen food made with tendon, pettitoe of cow and collagen powder according to current application.

### DETAILED DESCRIPTION OF THE PREFERRED EMBODIMENT

The following procedure is established by repeated experimentation to make a protein enriched transparent gelatin shape food. Raw materials are obtained from the tendon of a cow and pettitoe of cow. All the other materials used are food grade. The entire procedure is focused on making the product transparent. The method is comprised of 12 steps.

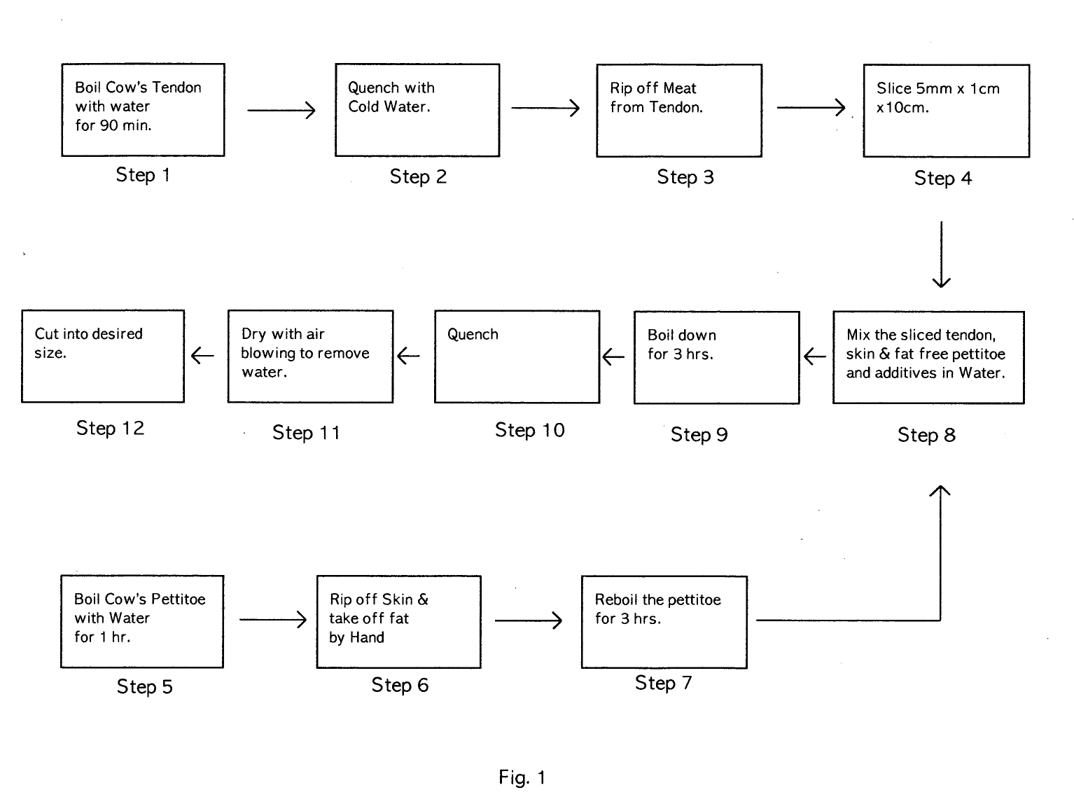

FIG. 1 is a schematic drawing of the procedure for manufacturing a gelatin shaped collagen food made with tendon, pettitoe of cow and collagen powder according to current application.

First step is to boil tendons from a cow in 100° C. water for 90 minutes. The tendons are not cut into small pieces to preserve the cell structure.

Second step is to quench the tendon with cold water at 15° C. It makes the meat easily separated from the tendon.

Third step is to rip off meats from the tendons.

After all the meat is removed, the tendons are sliced into a ribbon shape with 5 mm thickness, 1 cm width and 10 cm length in step 4. It is to increase the surface area of the tendon for the next step.

While steps 1 to 4 are proceeding; boil cow's pettitoe in water for one hour in step 5 to make it easy to rip off the skin therefrom and to remove fat too.

In the sixth step, rip off the skin of the cow pettitoe and remove fat by hand.

The seventh step is to boil the cow's pettitoe again in water for 30 minutes. Then the fat that is remaining in the hot water is discarded to remove residual fat because fat and small chips of skin from the pettitoe cloud the final gelatin product. This is not desirable for final product.

In the eighth step, the sliced tendons and ripped off pettitoe are mixed in water in 1:1:4 volume ratios. 1 tea spoon of caramel drop is added per 2.25 Kg (5 lbs) of the mixture. The caramel makes the final product with a thin brown color. Add gelatin powders up to 2.25 Kg per 2.25 Kg of the mixture and add 1 tea spoon of apple cider to 2.25 Kg of the mixture. Mixture without gelatin powder also make the desired final gelatin shape collagen food product. Any kind of desired additives can be added in this step. For example, sliced red pepper, green onion, steamed walnut, fruits, etc. can be added.

The ninth step is boiling down to make a gelatin product. Heat the mixtures prepared in the eighth step slowly for 3 hours. Vigorous boiling is avoided to prevent air bubble trapped therein. Temperatures between 75° C. to 98° C. are preferred. After 3 hours, the mixture starts to gel-late.

In tenth step, put the gel-lating mixture in a mold and quench as soon as possible. In this quenching step, water comes out of the gelatin structure.

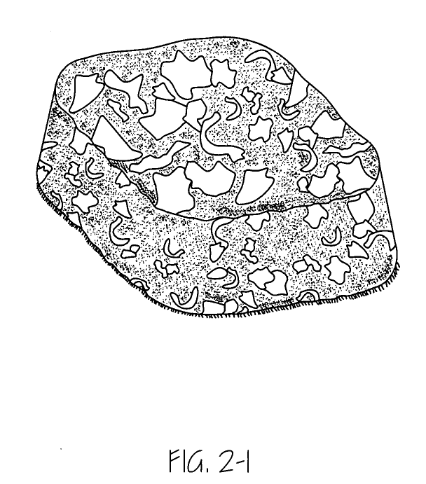

In eleventh step, dry out the gelatin structure by blowing air at room temperature for four hours to drive out all the moisture trapped therein to make the gelatin structure become a transparent and resilient gel. FIG. 2 is a photograph of molded gelatin shape collagen food made with tendon, pettitoe of cow and collagen powder according to the current application. The molded product is transparent and has a light brown color.

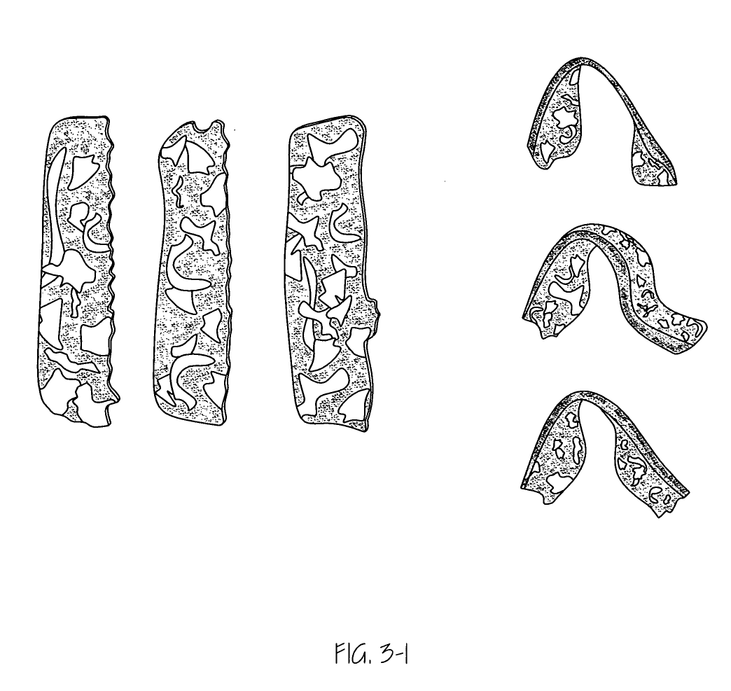

Twelfth's step is to cut them into desired size. FIG. 3 is a photograph of the sliced gelatin shape collagen food made with tendon, pettitoe of cow and collagen powder according to current application. The final product looks a slight brown transparent gel. Product shown in lower part of FIG. 3 is to emphasize the color of the final gelatin shape collagen food product.

The final gelatin shape collagen food product is chewy and the mouth feeling is familiar to kids and friendly for elderly person whose teeth are not healthy. Therefore, elderly can person easily compensate for proteins without severe effort to bite or chew meat.

What is claimed is:

1. A method of manufacturing a transparent gelatin shape collagen food made with tendon and pettitoe of cow that is comprised of;
first step of to boiling tendons from a cow, not cut into small pieces, in 100° C. water for 90 minutes,
and
second step of quenching the tendon with cold water at 15° C. to makes the meat easily separated from the tendon,
and
third step of ripping off meats from the tendons,
and
fourth step of slicing the tendons into a ribbon shape of 5 mm thickness, 1 cm width and 10 cm length to increase the surface area of the tendon,
and
fifth step of boiling cow's pettitoe in water for one hour to make it easy to rip off the skin therefrom and to remove fat,
and
sixth step of ripping off skin of the cow pettitoe and remove fats by hand,
and
seventh step of boil the cow's pettitoe again in water for 30 minutes followed by discarding the hot water to remove residual fat,
and
eighth step of mixing the sliced tendons and ripped off pettitoe in water in 1:1:4 volume ratios and adding 1 tea spoon of caramel drop and adding 2.25 Kg of gelatin powder and adding 1 tea spoon of apple cider to 2.25 Kg of the mixture,
and
ninth step of boiling down the mixture with additives slowly for 3 hours at a temperature of 95 C to avoid vigorous boiling that may form air bubble trapped in the mixture,
and
tenth step of putting the gel-lating mixture in a mold and quench,
and
eleventh step of drying out the gelatin structure by blowing air at room temperature for four hours to drive out all the moistures trapped therein make the gelatin structure become transparent and resilient,
and
twelfth's step of cutting the transparent and resilient gelatin structure into a desired size.

2. A method of manufacturing a transparent gelatin shape collagen food made with
tendon and pettitoe of cow that is comprised of;
first step of to boiling tendons from a cow, not cut into small pieces, in 100° C. water for 90 minutes,
and
second step of quenching the tendon with cold water at 15° C. to makes the meat easily separated from the tendon,
and
third step of ripping off meats from the tendons,
and
fourth step of slicing the tendons into a ribbon shape of 5 mm thickness, 1 cm width and 10 cm length to increase the surface area of the tendon,
and
fifth step of boiling cow's pettitoe in water for one hour to make it easy to rip off the skin therefrom and to remove fat,
and
sixth step of ripping off skin of the cow pettitoe and remove fats by hand,
and
seventh step of boil the cow's pettitoe again in water for 30 minutes followed by discarding the hot water to remove residual fat,
and
eighth step of mixing the sliced tendons and ripped off pettitoe in water in 1:1:4 volume ratios and adding 1 tea spoon of caramel drop and adding 1 tea spoon of apple cider to 2.25 Kg of the mixture,
and
ninth step of boiling down the mixture with additives slowly for 3 hours at a temperature of 95 C to avoid vigorous boiling that may form air bubble trapped in the mixture,
and
tenth step of putting the gel-lating mixture in a mold and quench,
and
eleventh step of drying out the gelatin structure by blowing air at room temperature for four hours to drive out all the moistures trapped therein make the gelatin structure become transparent and resilient,
and
twelfth's step of cutting the transparent and resilient gelatin structure into a desired size.
